(19) United States
(12) Patent Application Publication
(10) Pub. No.: US 2018/0225715 A1
(43) Pub. Date: Aug. 9, 2018

(54) AUTOMATIC GENERATION OF INTERACTIVE WEB PAGE CONTENT

(71) Applicant: ARKADIUM, INC., New York, NY (US)

(72) Inventors: Robert Caliolo, Syosset, NY (US); Thomas Rassweiler, New York, NY (US); Kenny Rosenblatt, New York, NY (US); Jessica Rovello, New York, NY (US); Stanislav Tkachenko, Brooklyn, NY (US)

(21) Appl. No.: 15/427,804

(22) Filed: Feb. 8, 2017

(51) Int. Cl. G06Q 30/02; G06F 17/27

(52) U.S. Cl. CPC G06Q 30/0263; G06F 17/2785

(57) ABSTRACT

Systems and methods are described for dynamically generating contextual interactives. In various aspects, the content of web page can be analyzed to determine one or more semantic rules associated with the web page. The semantic rules can include the keywords or the entities of the webpage, which can be used to define a context type for the web page. The context type for the web page can include, for example, a financial context type, an entertainment context type, a sports context type, a technical products context type, or any other context type associated with a web page or news article that appears within a web page. A contextual interactive may then be generated based on the context type for the web page. The contextual interactive may then be embedded within the web page such that the contextual interactive is operable to allow a user to interact with the contextual interactive.

### FIELD OF THE DISCLOSURE

The present disclosure generally relates to automatic generation of interactive web page content and, more particularly, to the dynamic generation of one or more contextual interactives based on a context type of a web page, where the contextual interactives are operable to be used by users of the web page.

### BACKGROUND

Modern-day publishers and newsrooms experience increased difficulty in attracting and retaining online audiences and users, and can experience particular difficulties in attracting and retaining users of a younger demographic. Even worse, many common solutions to attracting users can have a deleterious effect on a publisher's or a newsroom's brand integrity, e.g., in a scenario in which the publisher or newsroom offers momentary “click bait” that provides revenue, but that ultimately discourages repeat visits or poisons customer loyalty.

Strong engagement Key Performance Indicators (KPI), such as high page visit counts, strong time on site, and low bounce rates (e.g., the percentage of visitors that left without taking any actions on the page), typically allow publishers to charge more money to advertisers and thereby increase publisher revenue. However, user engagement driving KPIs for publisher and newsroom web pages is getting worse due to the rise of a vast number of alternative means for users to access news and articles, such as via mobile and social platforms, such as Facebook.

### BRIEF SUMMARY

Thus, publishers and newsrooms would benefit from contextual, interactive content that increases engagement on their web pages, but such publishers and newsrooms typically lack the technical sophistication and resources to create such content at scale. For example, because of the aforementioned issues, many of the publishers or newsrooms face declining resources and cannot impose an increased workload on their already overburdened and/or reduced staff.

For the foregoing reasons, there is a need for systems and methods for dynamically generating contextual interactives that drive user engagement within a web page. As described by the various embodiments herein, a software platform (also described herein as the “InHabit platform” or “InHabit”) is disclosed as a next-generation publishing solution that extends editorial content both factually and functionally. InHabit assists publishers with increasing user engagement, creating an opportunity for publishers, newsrooms, or other website owners or managers to improve user time-on-site, interaction and, therefore, revenue of the website owner or manager.

In various embodiments, InHabit provides an online software framework that automatically and contextually delivers interactive content for end user enjoyment. As described herein, in various embodiments, the InHabit platform can analyze a web page to identify the most frequently used keyword or entities. Once identified, the InHabit platform can use this information to generate and embed contextual and relevant “interactives” in the web page for users to operate. Accordingly, the InHabit platform provides an automatic, scalable, and infinite content solution that keeps online users engaged with the web site associated with the publisher, newsroom, owner, manager, etc.

The contextual interactives, also as described herein as “Factives,” can combine “gamified” interfaces (e.g., which provide online content presented as a trivia or other game for user interaction) with massive data APIs to create interactive content at scale. The Factives may operate as entirely original content assets by providing an interactive and programmatically-generated infographic that boosts engagement and activity, and increases user time spent on each publisher's or newsroom's site. In embodiments, the InHabit platform may use artificial intelligence, such as text classification and semantic analytic services, that require no effort to maintain, and is designed to align with a publisher's or newsroom's business goals. As described herein, JavaScript, Cascading Style Sheets (CSS), VBScript, or any other suitable code can be associated with a webpage that can analyze the webpage content for various keywords, phrases, entities, and other relevant content. From this analysis, an interactive portion may be generated and embedded in the web page, where the interactive portion is the Factive that provides, for example, quizzes, games, or other interactive content that aligns with the relevant content of the web page.

Accordingly, in various embodiments disclosed herein, systems, methods and instructions, stored in a non-transitory, tangible computer-readable medium, are described for dynamically generating one or more contextual interactives. As described herein, the content of web page can be analyzed to determine one or more semantic rules associated with a web page. The semantic rules can include, for example, the keywords or the entities of the webpage, which can be used to define a context type for the web page. The context type for the web page can include, for example, a financial context type, an entertainment context type, a sports context type, a technical products context type, or any other suitable content type associated with a web page or news article that appears on a web page. A contextual interactive may then be generated based on the context type for the web page. The contextual interactive may then be embedded within the web page such that the contextual interactive is operable to allow a user to interact with it.

In some embodiments, the act of generating a contextual interactive can include using one or more context modules, where each of the one or more context modules is associated with a respective context type. In certain aspects, the contextual interactive can comprise an integration interface, and the act of generating the contextual interactive includes accessing a remote server to retrieve context-relevant data related to the context type, resulting in the integration interface being updated with the context-relevant data.

In other embodiments, the contextual interactive can be generated based on a chain of display rules that define an order of display priority for a first context module and a second context module. Other rules may include, for example, user display filters (e.g., filters for determining which interactive to display for which users, e.g., displaying different contextual interactives for Facebook users than for non-Facebook users), or a number of times to display the contextual interactive to the user based on the user's number of visits to the web page.

In certain embodiments, online advertisements may be embedded within the web page along with the contextual interactives, and the online advertisements are also based on the context type for the web page.

In further embodiments, an online computer system is described that is configured to provide contextual information to client computing devices for the dynamic generation of contextual interactives. The online computer system may be configured to receive a request for context-relevant data from a client device, where the context-relevant data is associated with a context type for a context module associated with a web page. The online computer system can then respond to the request by sending context-relevant data to the client device, and the client device uses the context-relevant data to generate a contextual interactive for embedding in the web page.

In certain embodiments, the request to the online computer system causes the online computer system to access one or more online services associated with the online computer system to facilitate the response. The online services can include, for example, an app service, a module service, a semantic service, a search service, a movie service, a stock service, a sports service, or a content delivery network service.

In other embodiments, the online computer system can receive a request for one or more context modules which can be sourced, for example, from the module service to cause the computer system to send the module(s) to the client device for loading, such as via caching or storage at the client device. In certain aspects, the context modules can expose an integration interface used to generate the contextual interactives on the web page.

In some embodiments, the request received by the online computer system can be based on configuration rules defined by a configure file. The configuration rules can define, for example, one or more of interactive module configuration rules, native ad configuration rules, semantic service configuration rules, or analytics configuration rules.

In certain embodiments, the online computer system may expose an administrative interface that can be configured to allow an administrator to create or manage one or more contextual modules, or other assets, for generating the one or more contextual interactives.

The InHabit systems and methods as described herein provide numerous benefits and advantages to publishers and newsroom operators over prior art techniques that merely provide or offer content recommendations, games, and/or user-generated content. For example, in some embodiments disclosed herein, the result of each user's interaction with a contextual interactive may be logged and used for various analytics to tailor the generation of future interactive content to specific goals and/or for specific types of websites.

In some embodiments, the InHabit platform relies on commonly used libraries, such as jQuery and Handlebars, to simplify the implementation and development of the InHabit platform for administrators, developers, or users of the InHabit platform. The InHabit platform further allows customization and configuration, including features such as display rules and preferred Factive type. Because of these and other features, the Inhabit platform can automatically scan a web page or web page article and dynamically generate and embed contextual, interactive content. Accordingly, InHabit provides systems and methods that both factually and functionally extend the content of publishers and newsroom web pages and related articles. Moreover, because of these features, the Inhabit platform provides brand safety, and is relevant and scalable for various types of content and users.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 illustrates a diagram depicting an example computer network 100, in which the disclosed embodiments may operate.

FIG. 2A illustrates a block diagram depicting software client-side components and services that may be used by the various embodiments as described herein.

FIG. 2B illustrates a block diagram depicting services, code or other assets that may operate on a server-side of the computer network of FIG. 1 and that may be used by the various embodiments as described herein.

FIG. 3A illustrates a sports-based Factive or contextual interactive.

FIG. 3B illustrates an entertainment-based Factive or contextual interactive.

FIG. 4 illustrates a flow diagram of an example method 400 for generating a Factive or contextual interactive.

FIG. 5 illustrates a flow diagram of an example method 500 for module execution.

FIGS. 6A and 6B illustrate a flow diagram of an example method 600 for generating a sport-based Factive or contextual interactive.

The Figures depict preferred embodiments for purposes of illustration only. Alternative embodiments of the systems and methods illustrated herein may be employed without departing from the principles of the invention described herein.

### DETAILED DESCRIPTION

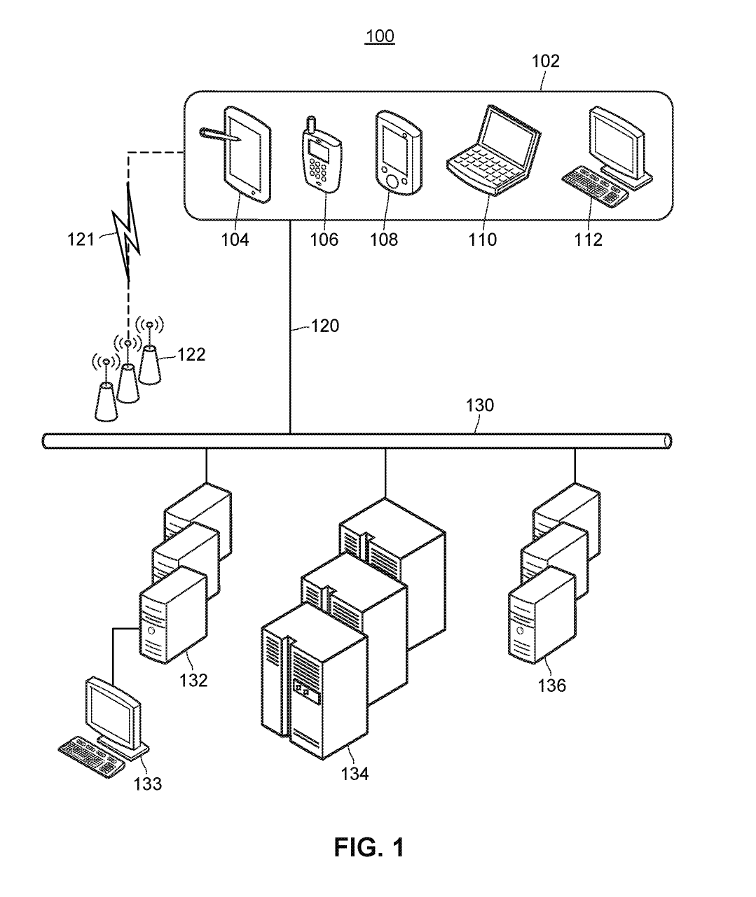

FIG. 1 illustrates a diagram depicting an example computer network 100, in which the disclosed embodiments may operate. The computer network 100 may include any number of client computing devices, including, for example, client computing devices 102. The client computing devices 102 may be implemented as any suitable type of computing device, such as, for example, a tablet computing device 104, a mobile phone device 106, a smartphone device 108, a laptop computer 110, or a personal computer 112.

The client computing devices 102 can include one or more processors for executing the instructions described herein and one or more memories (such as volatile random access memory (RAM) or non-volatile memory (e.g., EEPROM) for storing the instructions, context-relevant data, modules, interfaces, or other information, executables, or interpreted code as described herein). The client computing devices 102 can run any one or more of a number of operating systems, for example, Microsoft Windows, Apple Mac OS, Apple iOS, Google Android, Kindle Fire OS, Linux, etc. to implement the systems and methods as disclosed herein.

The client computing devices 102 can further include one or more suitable communication systems and/or components for facilitating computer network communications, such as one or more ports, transceivers, antennas, input/output interfaces, etc. For example, the transceivers of the client computing devices 102 may allow the client computing devices 102 to communicate over a computer network, such as computer network 130, via wire-based communication (120) using technology and communication standards such Ethernet (IEEE 802.3). To provide another example, the transceivers of the client computing devices 102 may allow the client computing devices 102 to communicate via wireless-based communication (121) using technology and communication standards such as WiFi (IEEE 802.11), Bluetooth technology, or mobile communication technology, including standards defined by the 3^{rd} Generation Partnership Project (3GPP), which can include the GSM (2G), UMTS (3G) and LTE (4G) mobile communication standards, for example.

The computing devices 102 may communicate with other computer systems, such as online computer systems 132-136, for example, via computer network 130. The computer network 130 may be comprised of any suitable number and/or type of private or public networks, including various Local Area Networks (LAN)s, for example, and/or various Metropolitan Area Networks (MAN)s. The computer network 130 may also include the various networks that comprise the Internet, so that communication between the client computing devices 102 and the online computer systems 132-136 can, in various embodiments, occur via the Internet.

The online computer systems 132-136 can include any suitable number of various servers, including single servers, server farms, and/or replicated servers that offer redundancy, failover, or recovery support. Server(s) 132, for example, may include one or more host servers that store or otherwise facilitate sending instructions, code, data, and/or other information to the client computing devices 102. For example, the host server(s) 132 may store or send contextual, relevant data (e.g., formatted in the extensible markup language (XML) in Hyper Text Markup Language (HTML) or in JavaScript Object Notation (JSON), etc.) in response to one or more requests from one or more of the client computing devices 102 to generate contextual interactives, as described herein.

In some embodiments, the contextual relevant data may be stored prior to the request for the data. In other embodiments, the server (e.g., one of online computer systems 132-136) may retrieve the data or other information from another source, such as local database, a remote database, a remote server or service, etc., before responding to the request. In some embodiments, the context-relevant data may be associated with a particular context type. For example, the context-relevant data may be associated with entertainment, sports, finance, products, or any other similar context.

In some embodiments, the host server(s) 132 may store or send instructions or code (e.g., JavaScript, Cascading Style Sheets (CSS), etc.) to one or more of the client computing devices 102 to facilitate the analysis, generation, and/or embedding associated with the contextual interactives as described herein. For example, as further described herein, in some embodiments, the instructions or code may be sent from the host server(s) 132 when a user of a client computing device first accesses or loads a web page associated with the InHabit platform or core.

The server(s) 132 may also include a number of services accessible by the client computing devices 102. For example, as described herein, the servers(s) may expose one or more of an app service, a module service, a semantic service, a search service, a movie service, a stock service, a sports service, or a content delivery network service. The services may be provided as web services by the server(s) 132, for example, through the use of a Representational State Transfer (RESTful) Application Programming Interface (API).

In the RESTful service embodiment, for example, a client device may submit any number of Hyper Text Transfer Protocol (HTTP) requests (e.g., GET and POST type requests) to cause the server(s) 132 to respond with related information or to perform related actions as described herein. The response from the server(s) 132 may include data and/or information in any number of data formats, including, for example, in the extensible markup language (XML), Hyper Text Markup Language (HTML), or in JavaScript Object Notation (JSON). The response may also include image data, or links to image data, for being displayed on a web page. The server(s) 132 may implement any suitable number of server technologies to facilitate the request and responses, including, for example, Java J2EE, Microsoft ASP.NET, Ruby on Rails, JavaScript Node.js, Phyton Django, PHP, etc.

The server(s) 132 may also include a local computing system(s) 133 for use in the administration, creation, or management of the context-relevant data, contextual modules, or other code and/or data for the generation and embedding of contextual interactives in web pages as described herein. While not shown, embodiments include the administration, creation, and management of the context-relevant data, contextual modules, and/or other code or data for the generation and embedding of contextual interactives in web pages, which may take place via a remote computer, for example, a remote administrative computer logged into the server(s) 132 via a Virtual Private Network (VPN), or other secure manner.

In some embodiments, the Inhabit platform may contain a number of administration tools, such as client dash boards that contain, for example, metrics including the number of page views, click through rates, etc., regarding user interaction with the contextual interactives or the web page(s) for which the contextual interactives are related. In other embodiments, the administration tools may include a developer's portal that allows for the uploading of modules, such as newly developed modules, for example. Still, in other embodiments, the administration tools may include an interactive containers tool that allows an administrator to manage containers, for example, by adding or removing interactive modules, or that allows the administrators to download code that can be used on a user's web page.

The client computing devices 102 or the server(s) 132 may access any number of third party server(s), including, for example, third party servers 134. Third party servers may include a number of online services that include web services for facilitating requests and responses, which may be similarly implemented, for example, as described for server(s) 132. The web services hosted via server(s) 134 may include, for example, cloud-based or online services provided by third parties such as Amazon, Google, or Microsoft. The services may include, for example, semantic based web services for analyzing the content or text of a web page. Other services that may include Content Network Delivery (CDN) services may include, for example, those provided by Akamai Technologies. Still further, other services may be provided by the third party server(s) 134 such as search services provided via Google's search service, app services, other data or information services (e.g. third party services that provide information regarding movies, stocks, or sports).

In other embodiments, such services may instead be provided by host services on server(s) 132. For example, in one embodiment, one or more client computing devices 102 may access a service from server(s) 132, in which case server(s) 132 could either respond with information, data, or instructions, or otherwise respond with information stored and located at server(s) 132. In another embodiment, one or more client computing devices 102 may request a service from server(s) 132, in which case the server(s) 132 may respond with a second request to server(s) 134, and upon receiving a response from server(s) 134, facilitate the response to the one or more client computing devices 102. Other embodiments may include a mixed or hybrid approach of the forgoing request and response paradigms. Still, in other embodiments, one or more client computing devices 102 may make a request directly to, and receive a respond directly from, the third party server(s) 134 with respect to any of the services described herein. For example, as described herein, one of client computing devices 102 may implement instructions for generating and embedding a context interactive, and may submit a request for the third party server 134 to perform a semantics service for a web page that the client device has accessed or loaded.

Server(s) 136 may represent a second set of host server(s) with the same or substantially the same functionality as host server(s) 132. Accordingly, the embodiments described herein with respect to server(s) 132 applies equally or substantially the same for server(s) 136. Each of the server(s) 132 and 136, however, may be configured via respective configuration files defining one or more configuration rules. The configuration rules can define, for example, interactive module configuration rules, native ad configuration rules, semantic service configuration rules, or analytics configuration rules, as described further herein.

Each of the configuration rules can cause the server(s) 132 or 136, or the contextual interactives that they facilitate, to behave differently on web pages that are rendered on any given client computing device 102. To provide an illustrative example, the interactive module configuration rules can define which contextual movie interactive to display (e.g., based on movie revenue) or to only show the contextual interactive 5 times for a given user. Furthermore, the semantic service configuration rules may define, for example, which semantic third party services (e.g., Amazon) to use, and the particular inputs or requirements for each third party service. Still further, the native ads service rules may provide, for example, an indicator whether to render native ads on the webpage with the contextual interactives. In some embodiments, the configuration rules may be provided by any of the server(s) 132 or 136 to one or more of the client computing device(s) 102. In other embodiments, the configuration rules may already be cached or stored on one or more of the client computing device(s) 102.

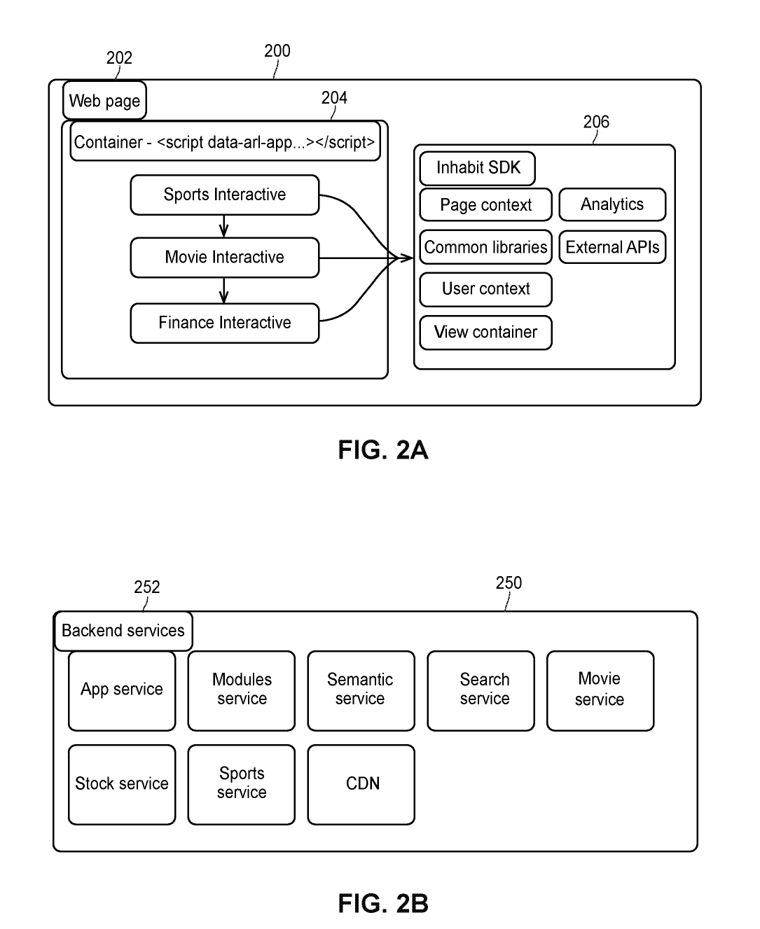

FIG. 2A illustrates a block diagram depicting software client-side components and services that may be used by the various embodiments as described herein. The client-side components and services can include, for example, scripts, instructions, code and/or data that execute on a web page. For example, the client-side components and services may include a container 204 (also referred to herein as an “Inhabit container”), which can comprise an HTML tag, such as a <script> tag, as shown in FIG. 2A. In other embodiments, the container can comprise or further include other HTML tags, such as <div> or <span> tags, for example. In embodiments, the container can provide configuration rules or instructions (e.g., the module configuration rules) for the Inhabit platform, such as, for example, via the configuration files as described herein. The Inhabit container may also contain one for more references to context modules for use in generating the contextual interactives as described herein. For example, as shown (204), the container may contain references to sports, movie, and finance modules used for the generation of sports, movie, and finance interactives, respectively.

In some embodiments, the Inhabit container can contain a chain of display rules that define, for example, user display filters, an order of display priority for a first context module and a second context module, or a number of times to display the contextual interactive to the user. The user display filters, for example, may define what contextual interactive to show a user based on an identification for the user. For example, the identification of a Facebook user may cause the Inhabit platform to generate a contextual interactive favorable to a Facebook user. In such an embodiment, the InHabit platform may access content from the user's Facebook profile for use with generating the contextual interactive. However, where a user is not detected as a Facebook user, a default contextual interactive may be displayed instead.

The Inhabit container can access, or otherwise be used by, the “Inhabit core,” which is part of the Inhabit Software Development Kit (SDK) (206), as shown in FIG. 2A. The Inhabit SDK allows InHabit hosts or developers (e.g., third party developers) to deliver unique interactive modules in coded packages that can include JavaScript, JSON, configurations, and visual assets such as CSS script and imagery, as further described herein. For example, in some embodiments, the Inhabit core is implemented as a JavaScript file referenced by the web page, which first loads on the web page. In some embodiments, the Inhabit core can render native online advertisements on the web page and expose the Inhabit API provided by the SDK. The Inhabit SDK also provides various JavaScript or common libraries, such as jQuery or the Handlebar template engine, for example, for use in rendering the contextual interactives as describe herein. In some embodiments, the client-side instructions, including instructions provided by the Inhabit SDK, for example, may update the web browser's or web page's Document Object Model (DOM) to cause the web page to render, animate, or otherwise display new data, positioning, or functionality of the contextual interactives, as described herein. The Inhabit SDK also provides access to native ads such as those provided by Triplelift.

The Inhabit API, as mentioned herein, provides a client API for accessing the backend information and services, such as the context-relevant data. In some embodiments, the Inhabit API provides access to external APIs, such as the contextual (semantic) API (e.g., in the form of a web service) for performing analytics on the page context of a web page and determining semantic rules, such as the entities or keywords of a web page. The keywords can assist, for example, in defining the context type of a web page and whether the web page is relevant to politics, sports (e.g., the National Football League), movies, entertainment, finance, etc. In some embodiments, the keywords can be words the user typed into the search engine to find the web page. In other embodiments, the keywords can be the words that appear in the title or other relevant parts of the web page, such as words that appear frequently, for example. The entities can also assist in defining the context type of a web page. For instance, the entities can determine a specific person, place or concept and can define how keywords (or other words) relate to one another or how other aspects of the web page content is related (e.g., Apple is a company; Tom Hanks is a person, etc.). In embodiments, the Inhabit SDK also provides access to a user's context (e.g., via cookies or other information exposed by the user's web browser). The SDK can also access a view container to render the contextual interactives on the web page.

FIG. 2B illustrates a block diagram depicting services, code, or other assets that may operate on a server-side of the computer network of FIG. 1 and that may be used by the various embodiments as described herein. For example, the server-side services or code 250 may include any of a number of backend services 252, including an app service, a modules service, a semantic service, a search service, a movie service, a stock service, a sports service, and a CDN service. In various embodiments, the services may be distributed across any of the server(s) 132, 136, or third-party server(s) 134. Accordingly, a client device (e.g., one of client computing devices 102) using any of the client-side components as described for FIG. 2A may access (e.g., via an API, such as a client-side web service API) any of the backend services described and depicted in FIG. 2B. The backend services are located, hosted or are otherwise made available, on any one or more of the server(s) 132, 134, and/or 136.

For example, the modules service of backend services 252 may be located on host server(s) 132. In some embodiments, the modules service can deliver, from the host server(s) to a client device, a contextual or interactive module (also described herein as an “Inhabit module”) as a package of files. In some embodiments, the Inhabit module is defined as single line of JavaScript on the web page provided to the client device that causes retrieval of the module. The Inhabit module can incorporate all plugins necessary for visualization, data analysis, and user interaction. For example, the Inhabit module can include assets for generating and rendering the contextual interactives on a web page. The assets can include, for example, images (e.g., Joint Photographic Expert Group (JPEG) or Portable Network Graphics (PNG) graphical images) and code, such as Cascading Style Sheet (CSS) code for manipulating or otherwise defining the display or view for the contextual interactive. This may be implemented, for example by using the CSS code and/or JavaScript code (e.g., an app.js JavaScript file that may also be included in the package) to render or otherwise control the behavior of the contextual interactives as a user interacts with the contextual interactive.

In some embodiments, the Inhabit module can expose a integration interface (e.g., the “Inhabit Integration Interface”), which can be code, such as JavaScript or CSS code with a set of methods for rendering, generating, or embedding the contextual interactive in a web page. For example, in some embodiments, generating the contextual interactive can include using the integration interface for a particular module and updating the interface with context-relevant data, such as the assets of the module (e.g., the images, CSS, and/or JavaScript or other information), to generate a specific contextual interactive based on the related assets. In such a manner, an infinite or a near-infinite number of permutations of contextual interactives can be generated. That is, each contextual interactive can be based on an particular interface or module, but updated or generated with any number, type, or kind of context-relevant images, code, or other data, such as, for example, for embedding into a user web page for gamification or user interaction purposes as described herein.

The modules, and its assets such as the images, code, or information, may be cached, stored, or otherwise loaded on the client computing device, such as within one or more computer memories of the computing device as described with respect to FIG. 1. The local caching of the assets can allow for quick manipulation of assets when a user begins to interact with the contextual interactive because the images and code will already be locally available on the client computing device when the user begins to interact with the contextual interactive. In this way, the client computing device would not have initiated a request to the host server (e.g., server(s) 132) to retrieve the module or the assets, which could slow down the user experience. In some embodiments, the module and/or assets can be cached immediately on the client computing device when the user accesses or loads the related the web page. For example, the cache procedure can take place as the result of one or more browser events (e.g., “onload”) called by the web browser when the web browser loads or otherwise executes or interprets the HTML for the web page. In additional embodiments, the modules or assets may be stored in one or more cookies of the user's browser on the client computing device, such that the modules and assets are immediately available to the client computing device without having to download them from the host server(s).

A module package may also include a default settings file, which may be formatted as a JSON file, for example, and which sets the default settings for the module. In some embodiments, the default settings may be used for generating the contextual interactive in the event that the host server (e.g., host server(s)132), specifies fewer than all settings used to generate the contextual interactives. Accordingly, in some embodiments, a client device executing instructions to generate and/or embed the contextual interactive can use settings from either the server(s) configuration file or from the configuration file specified in the module's package.

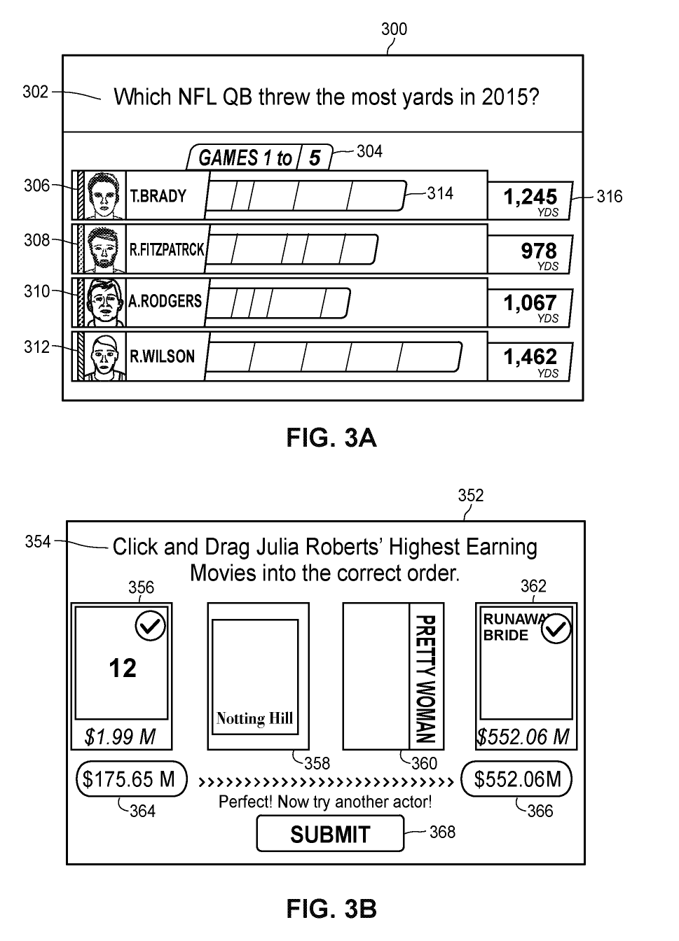

FIGS. 3A and 3B illustrate example embodiments of contextual interactives that may be generated and/or embedded by the Inhabit systems and methods as described herein. The contextual interactives can be provided as original content assets, which can be interactive, programmatically-generated infographics designed to boost user engagement and activity, and may function to increase user-time spent on each publisher's web site. As described, the contextual interactives are also referred to herein as “Factives,” which provide presentation layer objects for the Inhabit platform. In various embodiments, the InHabit platform can automatically create any suitable number of contextual interactives that both factually and functionally extend web page or article content. In some embodiments, Factives are written in human language by professional editors and populated by a data set having any suitable size. The InHabit platform can automatically select which Factive would be best to present to a user, which gives, for example, a publisher control over web page content and to align with the publisher's specific brand and business strategy.

For example, FIG. 3A illustrates a sports-based Factive 300. Specifically, FIG. 3A is a gamified, interactive sports stats and trivia infographic capable of automatically working with many (e.g., thousands) different NFL players. In the depicted embodiment of FIG. 3A, Factive 300 includes a title (302) posing the trivia question, “Which NFL QB threw the most yards in 2015”? The Factive 300 can include any number of games (304) (in this case five games) such that the user can develop an overall score across all the games. Factive 300 is populated with context-relevant data, such as the images, information, or code, for example, that make up the Factive. As shown in FIG. 3A, this may include images, names, and statistics (e.g., passing yards (316)) for each of the NFL players 306-312 depicted in Factive 300. The images can include graphic images in any suitable format, such as a bar (314) or pie chart, for example. In an embodiment, the graphic images may be vector-based graphics that are manipulated or scaled (e.g., by JavaScript, CSS, or other code or instructions) for the purpose of rendering or otherwise allowing interaction with the Factive 300.

In various embodiments, Factives are contextual and relevant. For example, a web page including an article on Tom Brady might cause the Inhabit platform to generate Factive 300, because Tom Brady is one of the NFL players (306) indicated in the Factive. A user can interact with Factive 300 by selecting the images or information that corresponds to an answer for the trivia question. For example, the user may select Tom Brady 306. Because the trivia question asks “which NFL QB threw the most yards in 2015,” a user selecting Tom Brady could receive an indication that he or she has selected a wrong answer (not shown), because as indicated, the Quarterback with the most yards in 2015 was Russell Wilson (312). Accordingly, a user selecting Russell Wilson (312) as the answer could receive an indication of a correct answer (not shown). In other words, the Factive 300 may initially be displayed such that the passing yards 316 information is not shown, but, instead, only shown after the user makes a selection from the list of quarterbacks.

Other Factives may be based on other context types. For example, FIG. 3B illustrates a Factive 352 based on entertainment. Factive 352 includes celebrity stats and trivia, and is playable by users. The Factive 352 can be configured to automatically work with many (e.g., 500,000) movies and/or celebrities, with the related context-relevant data being accessed from any of the server(s) 132-136. The example of Factive 352 is based on movies starring Julia Roberts. Factive 352 includes the title 354 including instructions on how a user can interact with the Factive (i.e., “Click and Drag Julia Roberts' Highest Earning Movies into the correct order”). In Factive 352, the user can drag each of the movie posters 356-362 in an attempt to identify the correct order according to the amount of revenue per respective movie. A Factive can thus indicate the user's current correct ordering. For example, Factive 352 indicates that the user has correctly ordered movie poster 356 and 362, where each has earnings of $175.65 million (364) and $552.06 million (366), respectively. In some embodiments, the indication may be shown immediately after the user drags the movie posters into position. In other embodiments, however, the user may select a submit button (368) to invoke the Factive to identify the correct (or wrong) selection(s).

Factives may include other context types such as financial-based, technology-based, cooking-based, politically-based, or any other context-based content type in which there is sufficient data to use or gamify. For example, a financial Factive (not shown) may gamify financial data and images in an easy-to-understand format using all publicly traded US companies with a substantial market history.

In some embodiments, the Factives, such as Factives 300 or 352, for example, may be implemented in a web page via a single line of code. In some aspects, the code may represent a “container” within the web page, as described herein with respect to FIGS. 2A and 2B. For example, a line of code that could correspond to the sports-related Factive 300 could be implemented as follows:

<script data-ark-configuration=“/Modules/App%2Fsport”
src=“//widgetapi- inhabit.as.arkadiumhosted.com/Widget/v1”></script>

As described herein, in some embodiments, the above line of code can correspond to one or more Factives. In other embodiments, one or more Factives represented by the above line of code, can be changed via an administration tool, such as the tools described for FIG. 1. For example, the administrative tool can be used to modify the Factive's corresponding configuration via a JSON configuration file. As another example, a line of could that could correspond to the movie related Factive 352, could be implemented as follows:

<script data-ark-configuration=“/Modules/App%2Fmovie”
src=“//widgetapi- inhabit.as.arkadiumhosted.com/Widget/v1”></script>

In both instances, the line of code identifies a particular module, e.g., “sports” or “movies,” used for generating the respective Factive.

In some embodiments, when a user lands on a web page using the Inhabit platform, the Inhabit core can instantly scan the page for written content and pull the most frequently mentioned keywords and/or entities. For instance, on a page entitled “Apple Just Released the New iPhone 7,” the Inhabit core may identify a page's keywords as: “tablets, phones, etc.,” and the page's entities as: “Apple—Company; iPhone—mobile phone.” The Inhabit Platform can use the keywords and/or entities to retrieve context relevant-data, such as information, images, and/or code. Once collected and aggregated, this information is delivered to a context module (e.g., the Inhabit Module) via a unique interface. The context module may then use context-relevant data to generate a contextually relevant and engaging Factive. In this particular example, the Inhabit may generate a Factive (not shown) that allows users to rank Apple's products in terms of sales numbers from most profitable to least, to rank the number of different product types sold (e.g., tablets, laptops, desktops, and phones), etc.

Thus, the Factives provide a number of benefits when used on a web page. For example, the Factives provide a new form of content for the web page, both factually and functionally, that can enhance web site owner's brand with high quality user experiences. In this way, the Inhabit platform can match and extrapolate on web page articles to create more meaningful and relevant user engagement. Because the Factives can be dynamically generated and received on demand, the Factives can scale instantly without requiring an in-house team of editors, graphics designers, programmers, etc. The Factives can thus encourage user interaction by creating active participation in the content experience, and can increase attention metrics on the page, thereby boosting both user views and engagement. Therefore, the Inhabit platform can create loyalty by motivating users to return for the experience.

In various embodiments, the Factives can be customized and be self-optimizable for the web pages on which they are embedded. In one embodiment, the modules may be developed by professional developers or editors and then made available via servers (e.g., server(s) 132), for retrieval from client computing devices. In another embodiment, the Inhabit platform may provide an editorial control panel, where setting parameters for a particular module can provide higher-function rules that can be set to react to different behaviors.

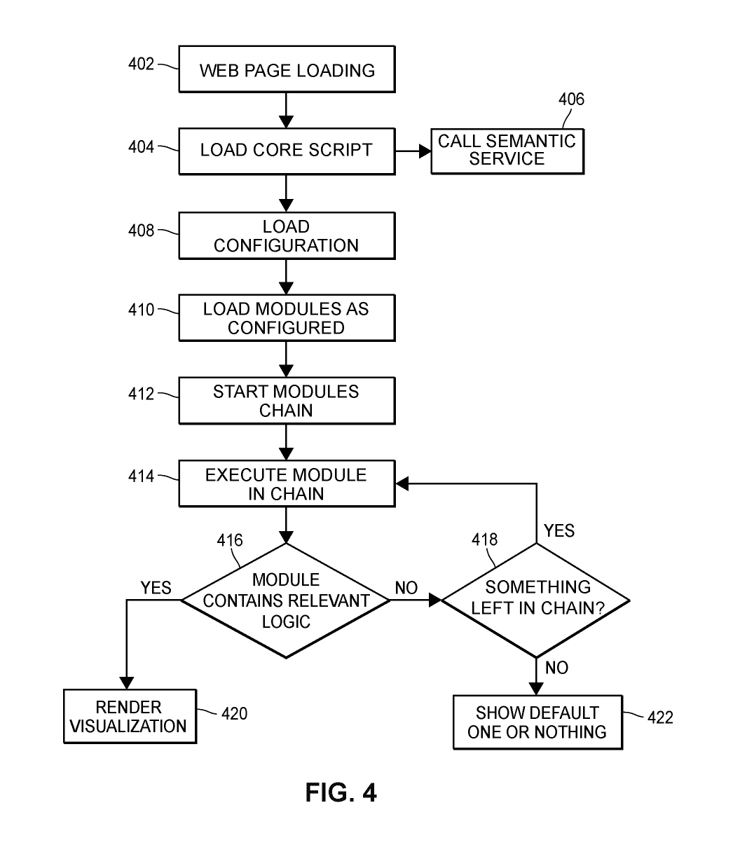

FIG. 4 illustrates a flow diagram of an example method 400 for generating a Factive or contextual interactive. Method 400 may begin when a web browser loads a web page (block 402). The loading of the web page may be the result of a user accessing a Uniform Resource Locator (URL) link associated with the web page directly or by clicking on another link that takes the user to the web page, such as a link provided by a search engine (block 402).

The web page loading can cause the Inhabit core script, as described with respect to FIGS. 2A and 2B, to be loaded, for example, via an “onload” event triggered in the web browser (block 404). In some embodiments, the core script may be already cached on the user's browser (block 404). In other embodiments, the core script may need to be downloaded from a server, for example, host server(s) 132, for loading, and, in some embodiments, for caching (block 404).

Method 400 may include, the core script, such as the code or API of the Inhabit SDK as described for FIGS. 2A and 2B, calling a semantic service to analyze the context of the web page and determining semantic rules associated with the web page (block 406). For example, when the Inhabit code, e.g., JavaScript, loads on a page, the InHabit code can send the URL of that page to a semantic service that analyzes its context using, e.g., a server-side or third party product, and passes the results to the modules added to the container (block 406).

For example, InHabit can use computer instructions and algorithms to read the page on which it is embedded (pulling meaning, taxonomy, and sentiment) to identify the context type of web page (block 406). In some embodiments, the call to the semantic service can include issuing a request to a third party server, such as third party server(s) 134, for example (block 406). Again, the third party products can include, for example, cloud-based or online services provided by Amazon, Google, or Microsoft, including, for example, semantic-based web services from these providers to analyze the web page that the interactive would be a part (block 406). In other embodiments, the call to the semantic service can include issuing a request to a host server, for example, any of host server(s) 132 or 136 (block 406). In some embodiments, the semantic service returns semantic rules, such as keywords and/or entities associated with the webpage. The semantic rules can define a particular context type for the webpage, such as defining what the web page (or an article of the webpage) pertains to, e.g., sports, entertainment, finance, etc. (block 406).

Method 400 may include loading the configuration(s) for the contextual interactives (block 408). The configurations files or script (which are either part of the module for the contextual interactive or the configurations) can retrieved from any of the host server(s) 132 and 136, as described herein (block 408). Furthermore, the configuration files or script can be stored as, or as part of, one or more JSON files. For example, method 400 may include loading the modules as they are configured in a configuration file, which is included as part of the module package (block 410)

Method 400 may include analyzing a chain of display rules, which in the present embodiment may define an order of display priorities for a group of context modules (which is also referred herein as a modules chain) (block 412). For example, the modules chain may include a first context module and a second context module. In some embodiments, the multiple modules can be added to a container by inserting a line of JavaScript code into web page being loaded, resulting in the modules being organized in order of priority (block 412). Other display rules can be based on user display filters (e.g., show one contextual interactive to Facebook users, but show another contextual interactive to non-Facebook users). Still, for other embodiments, other display rules can determine whether or not to display a contextual interactive based on the number times the contextual interactive has already been displayed to the user (block 412).

Method 400 may include executing the module chain to determine whether a first module should be used (block 414). The ordering of the first module can be determined based on, for example, user settings or a degree of relevance (e.g., a percentage) of the module to the web page context (block 414). For example, the Inhabit core can execute the first module in the Inhabit container to determine whether the module has identified itself as associated with data or information for the context type of the web page (e.g., NFL football for a web page associated with FIG. 3A) (block 414).

In an embodiment, method 400 may include determining whether the module indicates that it is relevant to the web page (block 416). For example, if the module is associated with movie information but the web page is relevant to NFL football, as described above, then method 400 may include the InHabit core executing the next module in the chain (block 414) if it is determined that additional modules remain in the module chain (block 418), and so on. If all modules return a negative identification and no modules remain in the claim, then method 400 may include the Inhabit core showing a default contextual interactive in the portion of the web page otherwise made available for the Factive or, in some embodiments, nothing at all (block 422).

However, if the module (or next module) is associated with the data or information, embodiments of method 400 include the InHabit core generating and embedding the contextual interactive within the web page, thereby rendering the visualization of the Factive (e.g., Factive 300) for interaction by the end user (block 420). Again, in some embodiments, the contextual interactive may be imbedded into various elements of an HTML web page, (e.g., a “<div>” or a “<span>” tag). As described herein, each contextual interactive can be generated using an integration interface exposed by the module and that pairs with context-relevant data, such as data retrieved from a host server(s) 132. In this way, multiple contextual interactives may be created from a single interface. In some embodiments, as described herein, the module may include images or groups of images, which may be cached on the client-side, for example, in the browser to allow for quick rendering by the client browser.

In some alternative embodiments, method 400 may include the Inhabit core providing an online advertisement that relates to the web page context in place of the Factive, in the event that no module can be found in the module chain (block 420). In other embodiments, when a relevant module is found, method 400 may include the Inhabit core displaying both the relevant Factive and the relevant online advertisement, such that the contextual interactive (Factive) is embedded along with related advertising for user engagement (block 420). In this way, users may experience web pages (or articles of web pages) with a new dimension of engagement, be prompted for their active participation in a content format that rewards their taking part in the web page activity.

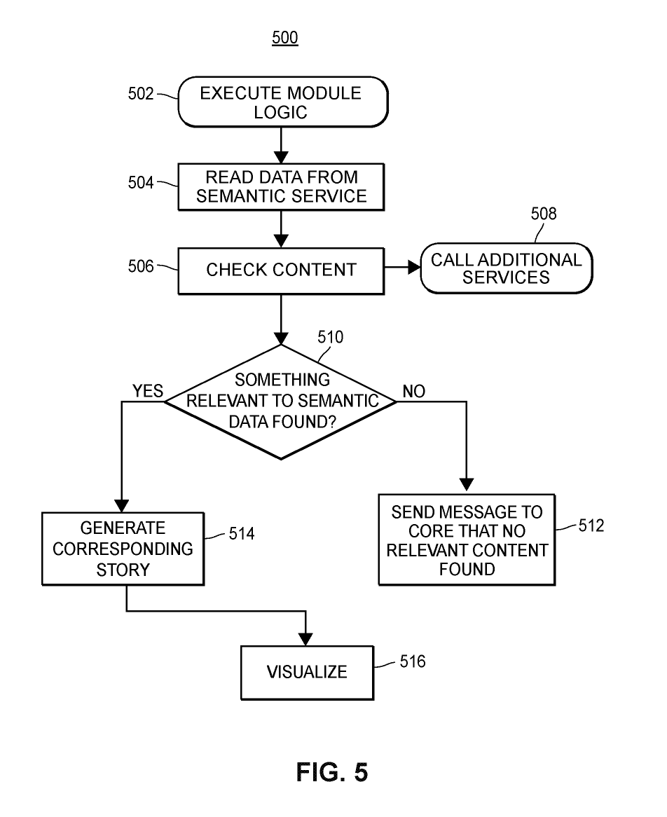

FIG. 5 illustrates a flow diagram of an example method 500 for module execution. Method 500 relates, at least in part, to the modules chain as described for FIG. 4. In an embodiment, method 500 may begin when the modules are executed (block 502) by the Inhabit core reading the data or information from the semantic service, such as the semantic rules (e.g., keywords and entities), returned by the semantic service as described above with reference to FIG. 4 (block 504).

Method 500 may include checking the content, such as content relevant data for a particular module, to determine whether the content relevant data relates to the semantic rules (block 506). In an embodiment, method 500 may include the Inhabit core calling additional backend services, for example, to retrieve additional content relevant data for a particular module (block 508).

In any event, method 500 may include the InHabit core checking to determine whether the content relevant data is relevant to the semantic rules and related data (block 510). If it is not relevant, then a message may be sent to the InHabit core that no relevant content could be found (block 512). In an embodiment, this may cause a default contextual interactive to be displayed such as an advertisement, or nothing at all, as described for method 400.

However, if the content relevant data is relevant to the semantic rules and related data (block 510), then method 500 may include generating the contextual interactive (block 514). Method 500 may include embedding the contextual interactive (block 514) on the web page, thereby visualizing the contextual interactive to the user (block 516).

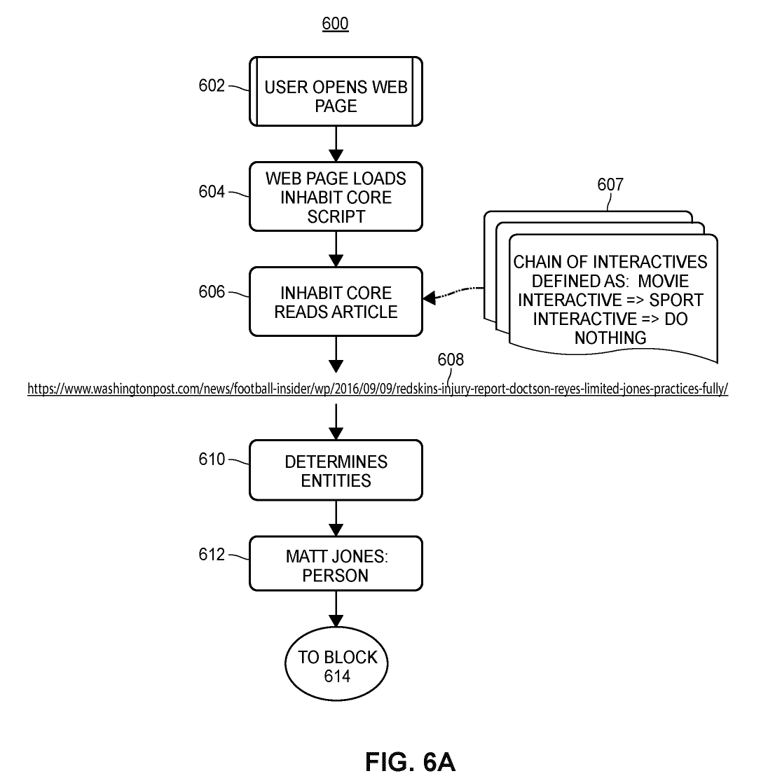

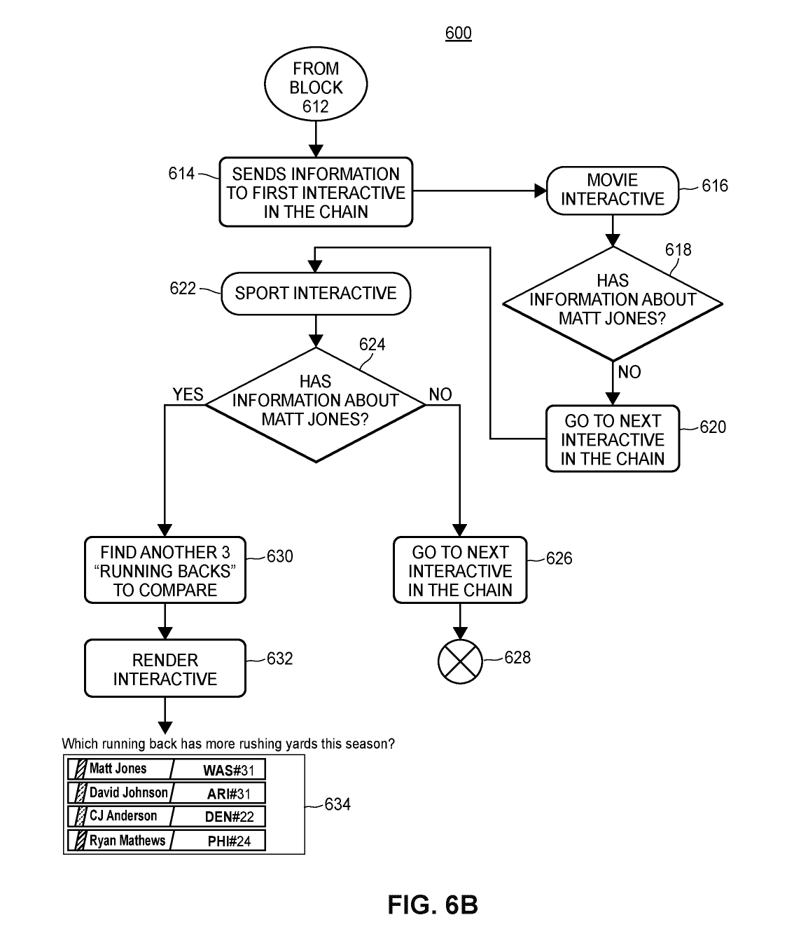

FIG. 6A and 6B illustrate a flow diagram of an example method 600 for generating a sport-based Factive or contextual interactive. In this example, the Factive 634 generated by method 600 includes the trivia question “Which running back has more rushing yards this season?,” and displays Matt Jones, David Johnson, C. J. Anderson, and Ryan Mathews, along with respective team colors, team name abbreviations, and uniform numbers, as choices for user selection.

Method 600 may be implemented in a similar manner as methods 400 and 500. Thus, where applicable, the implementation for methods 400 or 500 also apply with respect to method 600. Method 600 may include a user of a client computing device opening a web page by accessing an online link or by typing the web page's URL into a web browser (block 602).

Method 600 may include the web page loading the InHabit core script, which, as described herein, may be loaded from a local cache or otherwise retrieved from a host server, e.g., host server(s) 132 or 136 (block 604).

Method 600 may include the Inhabit core reading or analyzing the web page (or article within the web page), for example, by sending the contents of the web page or article to a semantics service (block 606).

Method 600 may include the web page defining a chain of interactive modules as describe herein, the chain being organized in this example to first display a movie interactive if the web page is relevant and, if not, to display a sports interactive. If the web page is still not relevant, then the chain results in nothing being displayed (as shown) (block 607). Although the modules chain is defined in the web page when the web page is loaded, method 600 may include using the modules chain later in the process, as further described below.

To provide an illustrative example, method 600 may include generating the web page URL 608 to include an article by the Washington Post related to NFL football, which is titled “Redskins Injury Report: Doctson, Reyes Limited, Jones Practices Fully.”

Continuing this example, method 600 may include determining the entities and/or keywords are by semantic analytics for the article at URL 608 (block 610). In some embodiments, the determination may be made by a remote semantic service, which can be called by the InHabit core, as described herein (block 610). In other embodiments, the determination may be made by the Inhabit core itself, for example, by executing semantic analytics via JavaScript local to the browser (block 610).

At block 612, the semantic service or semantic analytics may determine that the key words for the article at URL 608 are “Matt Jones” and that the entity, or relationship, is “Matt Jones is a Person.”

Method 600 may continue as shown in FIG. 6B. Thus, method 600 may include the InHabit core sending the keyword and entity information to the first module in the chain to potentially generate a contextual interactive for that module (block 614). In this example, the first module relates to a movie contextual interactive (block 616), which was specified by the module chain configuration as shown in FIG. 6A (block 607).

Method 600 may include the Inhabit core determining whether the movie module has information about Matt Jones (block 618). In this example, because the movie module does not have information about Matt Jones, then method 600 may proceed such that the InHabit core executes the next interactive in the module chain (block 620).

Continuing this example, the next module in the module chain relates to a sports interactive (block 622). Method 600 includes the InHabit core determining whether the sports module has information about Matt Jones (block 624). In the event that the sports module has no information about Matt Jones, then method 600 repeats such that the InHabit core attempts to execute the next module in the module chain (626). In this example, because the module chain rules (block 607) specify that the next step is to “Do Nothing,” then method 600 includes the InHabit core rendering nothing in that space on the web page for the Factive (block 628). In other embodiments, as described herein, an advertisement relating to the context of the web page may be rendered in place of the Factive (e.g., an advertisement for NFL football apparel or tickets for the example URL 608 of method 600) (block 628).

On the other hand, if the Inhabit core determines that the sports module has information about Matt Jones, then method 600 includes generating a contextual interactive (block 624). For example, method 600 may include the InHabit core requesting additional information or context-relevant data, such as information or data regarding three additional running backs, for use in the generation of the contextual interactive related to Matt Jones (block 630). Again, in some embodiments, the additional information or data may already be cached locally on the client computing device. In other embodiments, the InHabit core may need to request the additional information from a remote server, such as the host server(s) 132 or 136, or from a third party source, e.g., server(s) 134.

Method 600 may include generating the contextual interactive relevant to Matt Jones and embedding the contextual interactive in the web page for use and interaction by the user, once all the information is available to the InHabit core (block 632).

### Additional Considerations

Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other embodiments, the one or more processors or processor-implemented modules may be distributed across a number of geographic locations.

This detailed description is to be construed as exemplary only and does not describe every possible embodiment, as describing every possible embodiment would be impractical, if not impossible. One may be implement numerous alternate embodiments, using either current technology or technology developed after the filing date of this application.

Those of ordinary skill in the art will recognize that a wide variety of modifications, alterations, and combinations can be made with respect to the above described embodiments without departing from the scope of the invention, and that such modifications, alterations, and combinations are to be viewed as being within the ambit of the inventive concept.

The patent claims at the end of this patent application are not intended to be construed under 35 U.S.C. § 112 (f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. An online method for dynamically generating one or more contextual interactives using one or more processors, the online method comprising:
analyzing content of a web page to determine one or more semantic rules associated with the web page, the semantic rules defining a context type for the web page;
generating a contextual interactive based on the context type for the web page; and
embedding the contextual interactive within the web page,
wherein the contextual interactive is operable to allow a user to interact with the contextual interactive.

2. The online method of claim 1, wherein the semantic rules include one or more keywords or one or more entities.

3. The online method of claim 1, wherein the context type for the web page includes any one or more of the following: a financial context type, an entertainment context type, a sports context type, or a technical products context type.

4. The online method of claim 1, wherein the act of generating the contextual interactive comprises:
generating the contextual interactive using one or more context modules, each of the one or more context modules being associated with a respective context type.

5. The online method of claim 4, wherein the contextual interactive comprises an integration interface, and
wherein the act of generating the contextual interactive includes accessing a remote server to retrieve context-relevant data related to the context type and updating the integration interface with the context-relevant data.

6. The online method of claim 1, wherein the contextual interactive is generated based on a chain of display rules defining any one or more of the following: one or more user display filters, an order of display priority for a first context module and a second context module, or a number of times to display the contextual interactive to the user.

7. The online method of claim 1, further comprising:
embedding online advertisements within the web page, the online advertisements being based on the context type for the web page.

8. A tangible, non-transitory computer-readable medium storing instructions for dynamically generating one or more contextual interactives, when executed by one or more processors of a computing device, cause the computing device to:
analyze content of a web page to determine one or more semantic rules associated with the web page, the semantic rules defining a context type for the web page;
generate a contextual interactive based on the context type for the web page; and
embed the contextual interactive within the web page,
wherein the contextual interactive is operable to allow a user to interact with the contextual interactive.

9. The tangible, non-transitory computer-readable medium of claim 8, wherein the semantic rules include one or more keywords or one or more entities.

10. The tangible, non-transitory computer-readable medium of claim 8, wherein the context type for the web page includes any one or more of the following: a financial context type, an entertainment context type, a sports context type, or a technical products context type.

11. The tangible, non-transitory computer-readable medium of claim 8, wherein the non-transitory computer-readable medium further includes instructions that, when executed by the one or more processors, cause the computing device to:
generate the contextual interactive using one or more context modules, each of the one or more context modules being associated with a respective context type.

12. The tangible, non-transitory computer-readable medium of claim 11, wherein the non-transitory computer-readable medium further includes instructions that, when executed by the one or more processors, cause the computing device to generate the contextual interactive by accessing a remote server to retrieve context-relevant data related to the context type, and updating an integration interface that is included as part of the contextual interactive with the context-relevant data.

13. The tangible, non-transitory computer-readable medium of claim 8, wherein the non-transitory computer-readable medium further includes instructions that, when executed by the one or more processors, cause the computing device to generate the contextual interactive based on a chain of display rules that define any one or more of the following: one or more user display filters, an order of display priority for a first context module and a second context module, or a number of times to display the contextual interactive to a user.

14. The tangible, non-transitory computer-readable medium of claim 8, wherein the non-transitory computer-readable medium further includes instructions that, when executed by the one or more processors, cause the computing device to embed online advertisements within the web page that are based on the context type for the web page.

15. An online computer system configured to provide contextual information to one or more computing devices for the dynamic generation of one or more contextual interactives, the computer system comprising one or more processors configured to:
receive a request for context-relevant data from a client device, the context-relevant data being associated with a context type for a context module associated with a web page; and
respond to the request by sending context-relevant data to the client device,
wherein the client device uses the context-relevant data to generate a contextual interactive for embedding in the web page.

16. The online computer system of claim 15, wherein the request causes the online computer system to access one or more online services associated with the online computer system to facilitate the response, the one or more online services including any one or more of the following: an app service, a module service, a semantic service, a search service, a movie service, a stock service, a sports service, or a content delivery network service.

17. The online computer system of claim 16, wherein the one or more processors are further configured to receive a request for one or more context modules from the module service, and,
wherein the context modules are sent to and loaded by the client device.

18. The online computer system of claim 17, wherein each of the one or more context modules exposes an integration interface used to generate the contextual interactive.

19. The online computer system of claim 15, wherein the request is received based on one or more configuration rules defined by a configure file, the one or more configuration rules defining one or more of the following: interactive module configuration rules, native ad configuration rules, semantic service configuration rules, or analytics configuration rules.

20. The online computer system of claim 15, further comprising an administrative interface that is configured to allow an administrator to create or manage one or more contextual modules for generating the one or more contextual interactives.
